(19) United States
(12) Patent Application Publication
(10) Pub. No.: US 2006/0162406 A1
(43) Pub. Date: Jul. 27, 2006

(54) Vehicle tire lock

(75) Inventor: Jennifer Chen, Changhu City (TW)

Correspondence Address: BRUCE H. TROXELL, SUITE 1404, 5205 LEESBURG PIKE, FALLS CHURCH, VA, 22041, US

(73) Assignee: Vulcan Sports Co., Ltd.

(21) Appl. No.: 11/039,795

(22) Filed: Jan. 24, 2005

(51) Int. Cl. B60R 25/00

(52) U.S. Cl. 70/225

(57) ABSTRACT

A vehicle tire lock to prevent vehicle tires from being stolen includes a core seat, a upper duct, a lock assembly and a lower duct. The upper duct and the lower duct are extendable to run though the tires. Locking and unlocking operations may be performed through the core seat and lock assembly to prevent the vehicle tires from being stolen.

### BACKGROUND OF THE INVENTION

1. Field of the Invention

The invention relates to a vehicle tire lock that has a upper duct and a lower duct coupled in an extendable manner to run though tires, and a core seat and a lock assembly to prevent the tires from being stolen.

2. Description of the Prior Art

In the cold regions two types of vehicle tires are needed, one for the winter season and another for the summer season. For the tires of off-season, they are often being placed by the vehicle owner on the parking lot behind the vehicle. To prevent the tires from being stolen, the tires are strung together by a steel chain or steel cable, and fastened by a lock. While such an approach can guard the tires against thefts, it has drawbacks, notably:
1. The length of the steel chain or cable has to match the number of tires being held. Too short is useless, while too long takes too much space and tends to trip people and causes accidents, and also is untidy whether in use or not.
2. When the tires are strung by the steel chain or cable, the tires often are not stacked and aligned neatly. As a result, the tires tend to tumble when hit by external forces.

### SUMMARY OF THE INVENTION

In view of the aforesaid disadvantages, the present invention aims to provide a vehicle tire lock that consists of a core seat, a upper duct, a lock assembly and a lower duct. The upper duct and the lower duct are coupled and extendable to run through the axle holes of the vehicle tires. The core seat is coupled with the lock assembly to perform locking and unlocking operations to prevent the tires from being stolen.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is an exploded view of the lock assembly of the invention.

FIG. 4 is a schematic view of the invention in a locking condition.

FIG. 5 is a cross section taken on line I-I in FIG. 4.

FIG. 6 is a schematic view of an embodiment of the invention in use.

FIG. 7 is another schematic view of an embodiment of the invention in use.

FIG. 8 is a sectional view of the invention in a unlocking condition.

FIG. 9 is a cross section taken on line II-II in FIG. 8.

### DESCRIPTION OF THE PREFERRED EMBODIMENT

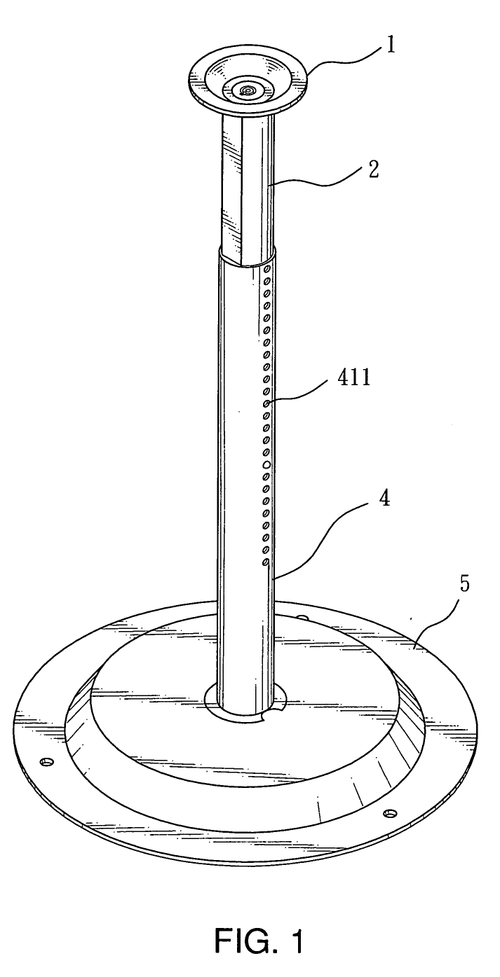

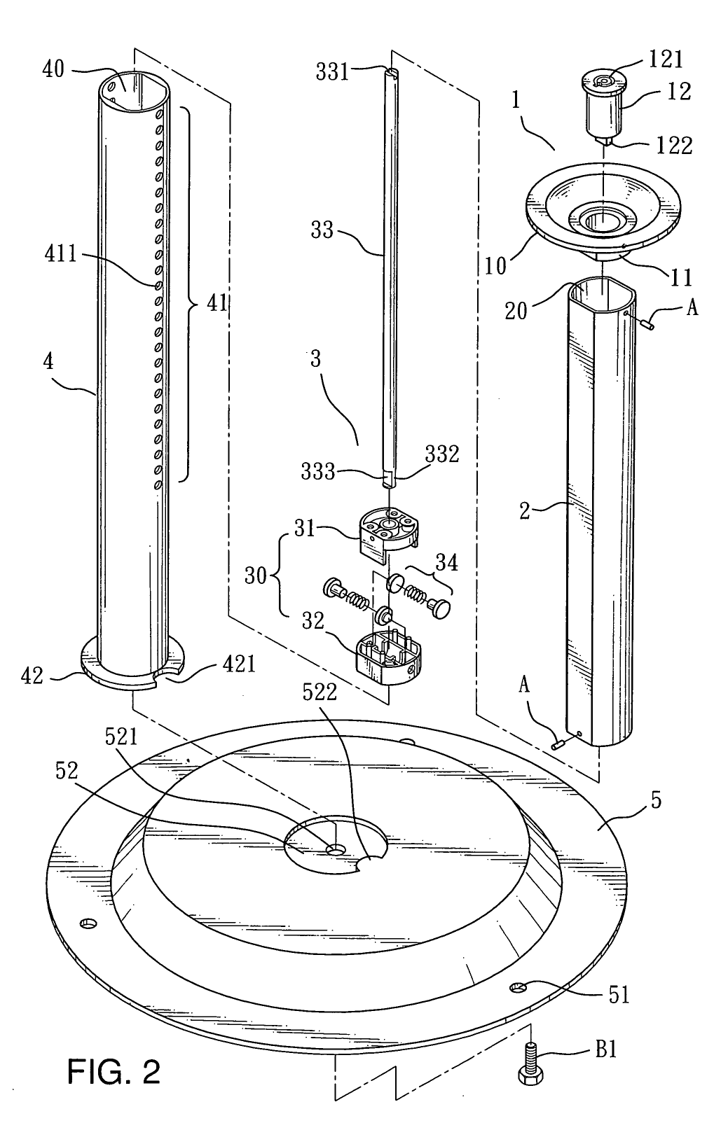

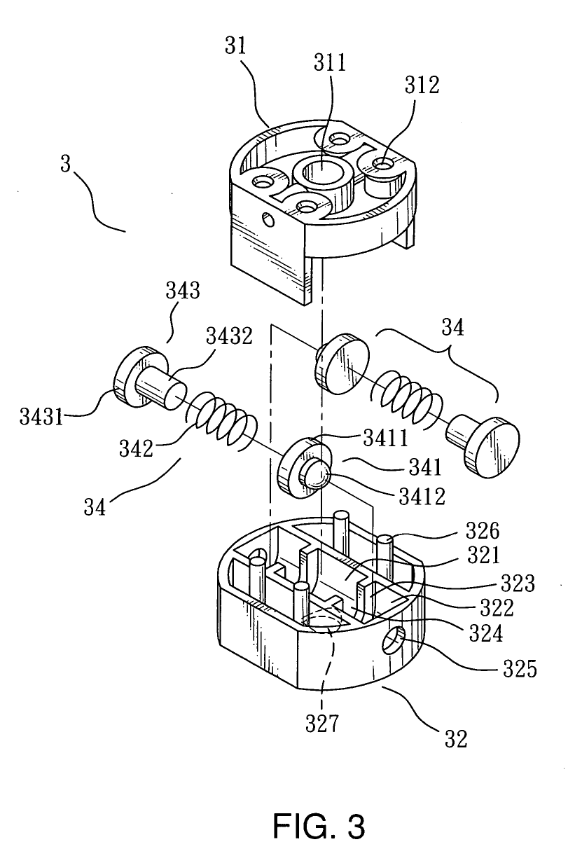

Referring to FIGS. 1, 2 and 3, the vehicle tire lock according to the invention includes a core seat 1, a upper duct 2, a lock assembly 3 and a lower duct 4.

The core seat 1 has a seat body 10 with a maximum width greater than the axle hole of vehicle tires. The seat body 10 has a fastening latch 11 on a lower side. The seat body 10 also holds a core 12 which has a keyway 121 on one end and a latch tongue 122 on another end.

The upper duct 2 is hollow and has a first inner hole 20 which has a upper end coupled with the fastening latch 11 and fastened by a pin A or soldering.

The lock assembly 3 includes a coupling dock 30 and a rod 33. The coupling dock 30 has one or more retaining assembly 34 which includes an elastic element 342, a bucking member 343 and an anchor button 341. The coupling dock 30 is coupled on a lower end of the upper duct 2 and fastened by another pin A or soldering. The coupling dock 30 includes a upper seat 31 and a lower seat 32. The upper seat 31 has one or more anchor hole 312 and an aperture 311. The lower seat 32 has one or more anchor strut 326, at least one bucking member housing chamber 321 and at least one side chamber 322. The bucking member housing chamber 321 and the side chamber 322 are separated by a spacer 323 which has a notch 324 in the center. The side chamber 322 has an opening 325 on an outer side. The lower seat 32 further has a trough 327 corresponding to the aperture 311 of the upper seat 31 to fasten to the lower end of the rod 33. The rod 33 has a coupling section 331 on a upper end to be coupled with and driven by the latch tongue 122, and a first action surface 332 and a second action surface 333 on a lower end.

The lower duct 4 is hollow and has a second inner hole 40 to house the upper duct 2 such that the upper duct 2 is movable upwards and downwards. The second inner hole 40 is ellipse (or a polygon) corresponding to the upper duct 2 to prevent the upper duct 2 from rotating during extending and retracting. The wall of lower duct 4 has at least one aperture 411 to form a longitudinal aperture column 41 to be latched by the anchor button 341 of the lock assembly. The lower duct 4 further has a flange 42 on a distal end with a perimeter greater than the axle hole of the vehicle tires.

On the retaining assembly 34 the elastic element 342 is coupled on a neck 3432 of the bucking member 343 of a smaller diameter. The bucking member 343 is held in the bucking member housing chamber 321, and has a bucking head 3431 of a larger diameter retained by the spacer 323. The neck 3432 passes through the notch 324 into the side chamber 322 to press a button head 3411 of the anchor button 341. The anchor button 341 has a jutting end 3412 passing through the opening 325 and extended outside under the elastic force of the elastic element 342 in normal conditions (referring to FIG. 5).

The invention further has a tray 5 which has a coupling seat 52. The coupling seat 52 has a fastening hole 521 in the center to couple with the flange 42 of the lower duct 4 and be fastened by a fastening element B 1. The coupling seat 52 further has an anchor lug 522 mating an anchor notch 421 formed on the periphery of the flange 42 to facilitate positioning during assembly.

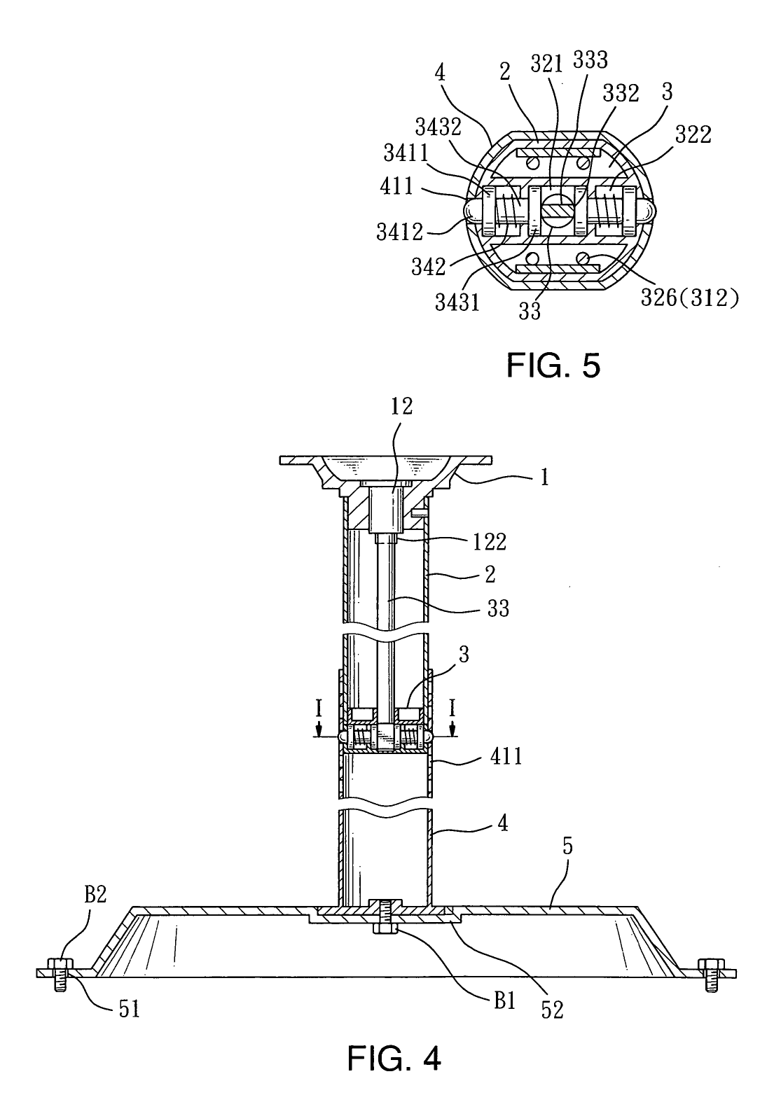

The tray 5 has one or more aperture 51 on the periphery to receive a fastening element B2 for fastening to the ground (referring to FIG. 4).

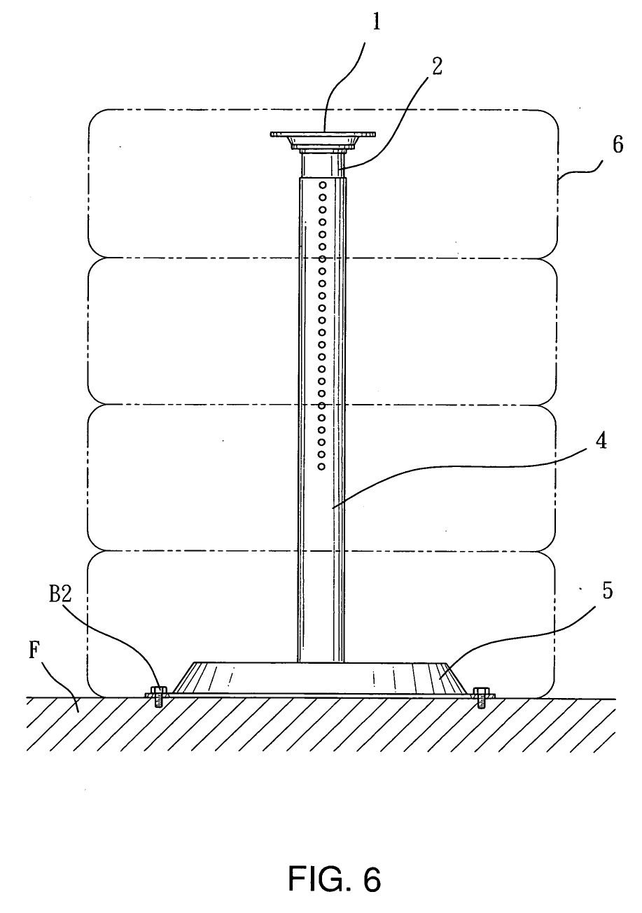

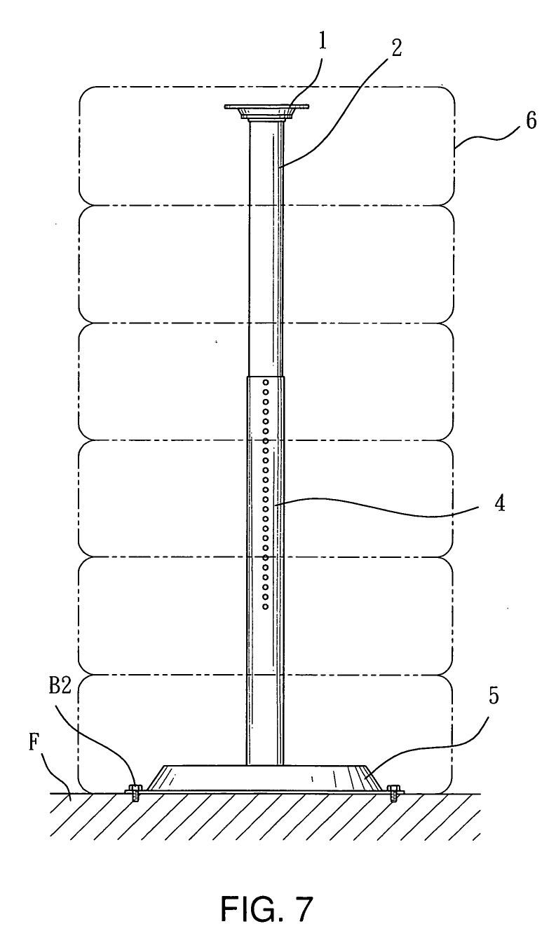

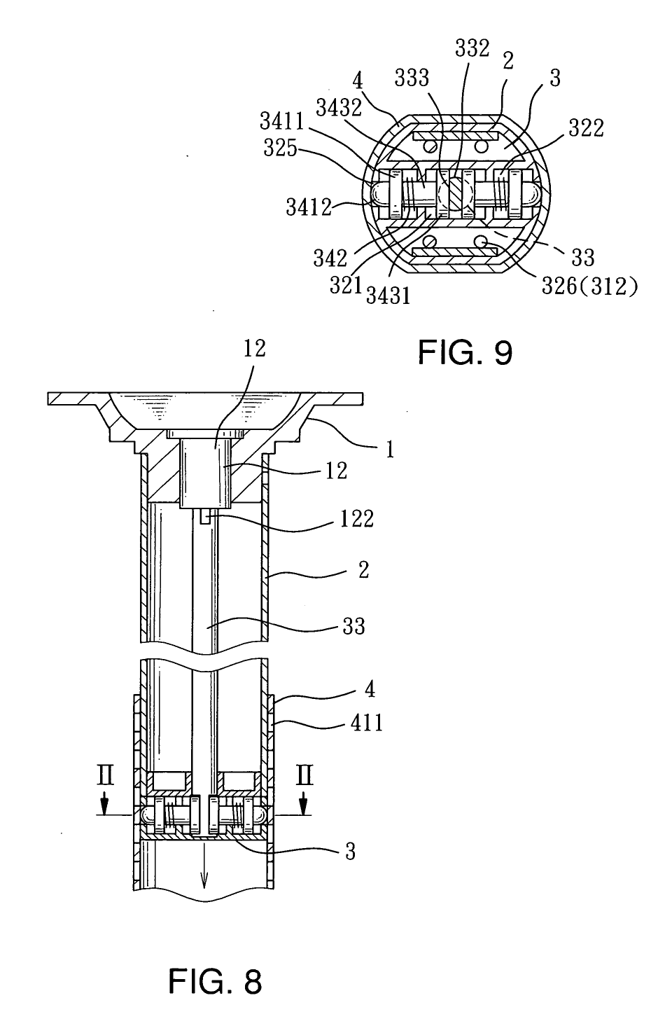

Referring to FIGS. 4 through 7, by means of the construction set forth above, when a user wants to lock vehicle tires 6, first, he/she pulls out the upper duct 2 from the lower duct 4; next, the tires 6 are coupled on the lower duct 4 through the axle hole; then insert the upper duct 2 into the second inner hole 40 of the lower duct 4, and move the upper duct to couple the anchor button 341 with the longitudinal aperture column 41 in a desired aperture 411 until the core seat 1 touches the vehicle tire at the top end. Turn the core 12 through a key to drive the latch tongue 122 and rod 33. The first action surface 332 presses the bucking member 343 so that the anchor button 341 cannot be retracted, and a locking condition is achieved (referring to FIG. 5). On the contrary, to remove the vehicle tires, referring to FIGS. 8 and 9, turn the latch tongue 122 of core 12 through the key to drive the rod 33. The second action surface 333 of the rod 33 is moved and spaced from the bucking member 343, thus the anchor button 341 may be retracted to release the locking condition. Hence the upper duct 2 may be pulled out from the lower duct 4, and the vehicle tires 6 may be removed.

I claim:

1. A vehicle tire lock, comprising:
a core seat including a seat body which has a maximum width greater than the axle hole of vehicle tires and a fastening latch on a lower side, and holds a core which has a keyway on one end and a latch tongue on another end;
a hollow upper duct having a first inner hole which has a upper end coupling with the fastening latch;
a lock assembly including a coupling dock and a rod, the coupling dock having a retaining assembly, the rod having a coupling section on a upper end to be coupled with the latch tongue and be driven; and
a hollow lower duct having a second inner hole to house the upper duct for the upper duct to be moved upwards and downwards therein, and at least one aperture on the duct wall thereof to form a longitudinal aperture column and a flange on a distal end thereof.

2. The vehicle tire lock of claim 1, wherein the retaining assembly includes an elastic element, a bucking member and an anchor button.

3. The vehicle tire lock of claim 1, wherein the rod has a first action surface and a second action surface on a lower end.

4. The vehicle tire lock of claim 1, wherein the flange has a perimeter greater than the axle hole of the vehicle tires.

5. The vehicle tire lock of claim 1, wherein the distal end of the lower duct is fastened to a tray.

6. The vehicle tire lock of claim 5, wherein the tray has at least one aperture on the periphery to receive a fastening element to fasten the tray to the ground.

7. The vehicle tire lock of claim 1, wherein the coupling dock includes a upper seat and a lower seat.

8. The vehicle tire lock of claim 7, wherein the lower seat includes a bucking member housing chamber and at least one side chamber.

9. The vehicle tire lock of claim 8, wherein the bucking member housing chamber and the side chamber are separated by a spacer which has a notch in the center.

10. The vehicle tire lock of claim 8, wherein the side chamber has an opening on an outer side.
